(19) United States
(12) Patent Application Publication
(10) Pub. No.: US 2012/0217190 A1
(43) Pub. Date: Aug. 30, 2012

(54) Pulsed Induction System for Fluids to a Combustion Chamber

(75) Inventors: Anders Thalberg, Hafslunsoy (NO); Steinar Slette, Hamar (NO)

(73) Assignee: Magnetic Emission Control AS, Koppang (NO)

(21) Appl. No.: 13/404,110

(22) Filed: Feb. 24, 2012

Related U.S. Application Data
(60) Provisional application No. 61/450,713, filed on Mar. 9, 2011.

(30) Foreign Application Priority Data
Feb. 24, 2011 (NO) 20110308

(51) Int. Cl. B03C 1/005; B03C 1/02

(52) U.S. Cl. 210/97; 210/222; 210/143; 96/2

(57) ABSTRACT

An apparatus for magnetic pre-treating of a first or second flow of fluid (11, 12) in one supply pipe (1, 1′) to a combustion chamber (6), wherein at least one magnetic field (22) is extended through said flow of fluid (11, 12) passing through said supply pipe (1, 1′), wherein said magnetic field (22) is induced by at least one electromagnet (2) each said electro magnet comprising an electrical coil (21) provided with energy from a voltage source (3); with an electrical pulse generator (4) provided with voltage from said voltage source (3) and arranged to generate electrical pulses (p) with a desire frequency (f) to said electrical coil (21).

### INTRODUCTION

The invention is an electromagnetic device for pre-treating flow of fluids such as air and fuel prior to combustion in an internal combustion engine such as a piston engine or a gas turbine to increase efficiency while unwanted or harmful environmental emissions reduced.

### GENERAL BACKGROUND

Attempts to influence and improve the combustion processes by delaying the combustion process or supply lines, for a magnetic field, has been ongoing at least since about the 1960s. Installation of the magnets to prevent iron filings from engine production to get into aircraft engines have been used during World War II.

### Introduction to Problems to be Solved

It is believed that magnetic fields may improve combustion processes by magnetically influencing the fluids that run into the burning process, even if the applicant knows no full scientific explanation of such electromagnetic pretreatment of fluids would work. It is through practical testing and isolated experiments that the applicant has been able to develop practical magnetic devices designed for this purpose, see e.g. NO316089, U.S. Pat. No. 7,650,877, NO329826.

### In General

In systems for magnetic pretreatment of fuel or combustion air is now used permanent magnets. These may also be performed as electromagnets but it takes a lot of electric current in order to generate a magnetic field corresponding to the field from a permanent magnet. Permanent magnets based on neodymium are very strong. This makes the assembly line work difficult because of the magnetic forces on everything in the vicinity that may be magnetized by permanent magnets in the process. When these permanent magnets mounted on large engines, where the magnets are scaled relative to the size of the fluid flow, one will end up quickly with the magnets of a strength that may be dangerous to work with because one may risk crushing.

On some systems, it is also not very advisable to mount heavy permanent magnets because the weight of the magnets will provide long-term damage to the air and fuel pipe and thus it would mean that you have to reinforce the structures in an undesirable degree.

Today, the applicant uses several permanent magnets mounted in sequence on fluid supply pipe to achieve enhanced effects on engines and combustion plant. The device according to the present invention occupies less space than the one used in prior art, and also weighing less.

The present system works dynamically, so that it better works by variations of the liquid and gas velocities in a given engine or turbine system.

Strong permanent magnets are made of rare earth metals, which is a limited resource. An electromagnetic system benefits from common electrical conductors such as copper or aluminum, and cores mainly of iron, and may thus be supplied in large volumes without the same restrictions as you run the risk of rare earth metals.

### BRIEF FIGURE CAPTION

FIG. 1 is a principal drawing of a simple electromagnet used in the invention and which illustrates a longitudinal section of a pipe for fluids (e.g. Air or fuel or a mixture thereof) with an electromagnet arranged to generate a magnetic field perpendicular to the flow of fluid in the pipe and a pulse generator arranged to form a current pulse through the electromagnet. The pulse generator has a voltage source and it is also arranged a switch to form the desired direction of the flow and thus the magnetic field.

FIG. 2 illustrates an embodiment of the invention shown in FIG. 1 in that it is arranged two or more electromagnets on the supply pipe, here three electromagnets.

FIG. 3 shows two examples of the pulse train of magnetic pulses or voltage pulses to an electromagnet that generates magnetic pulses.

FIG. 4 shows the longitudinally directed magnetic field, shown in the lower part, according to prior art, and cross-oriented induced magnetic field according to the present invention shown in the top of the drawing.

### DESCRIPTION OF EMBODIMENTS OF THE INVENTION

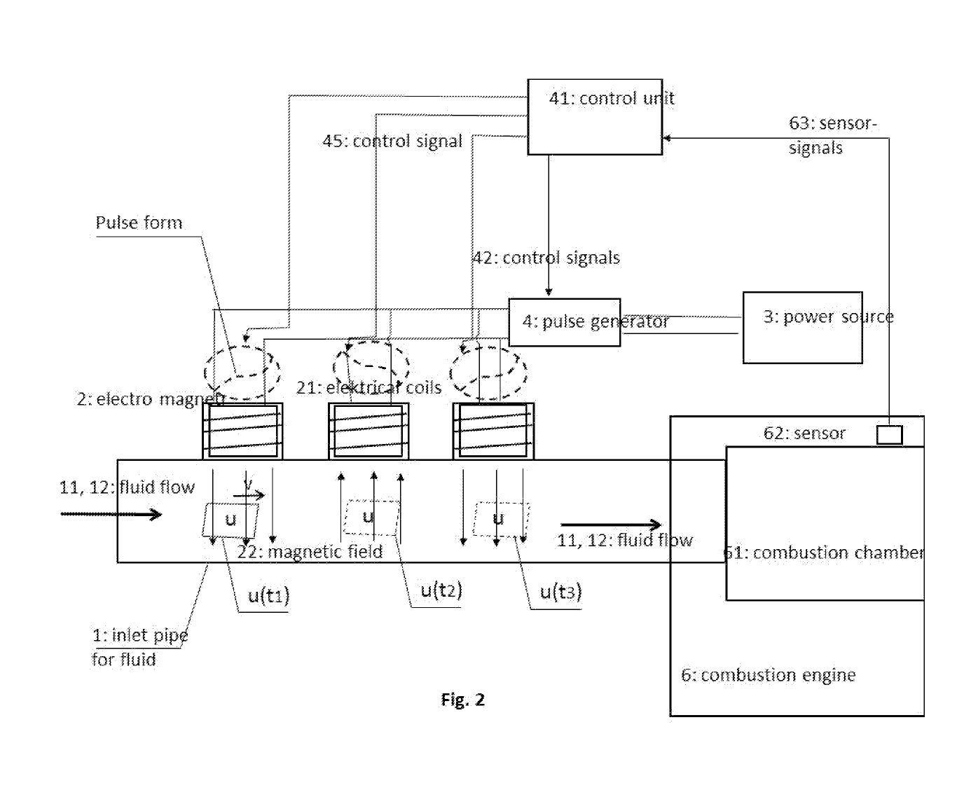

The invention will be described below in various embodiments. The invention is illustrated in an apparatus for magnetic pre-treating of a first or second flow of fluid (11, 12) in one supply pipes (1, 1′) wherein the fluid flow will run to a combustion chamber (61). The first fluid flow may be a fuel flow (11) and the second fluid flow may be an air flow (12). At least two magnetic fields (22) are led through the fluid flow (11, 12) which runs through the supply pipe (1, 1′), please see FIG. 2

Each magnetic field (22) may have an arbitrary direction through the fluid flow (11, 12) and just run through some of the fluid flow either as connected in fluid flow longitudinal directed or cross-section. An example of this is that the magnetic field (22) runs generally across a small section of a supply pipe (1, 1′) that guides a fluid flow, either it is air flow or fuel flow.

In a preferred embodiment of the inventor the magnetic fields are formed as transverse field relative to the axis of the supply pipe (1, 1′). This has several advantages.

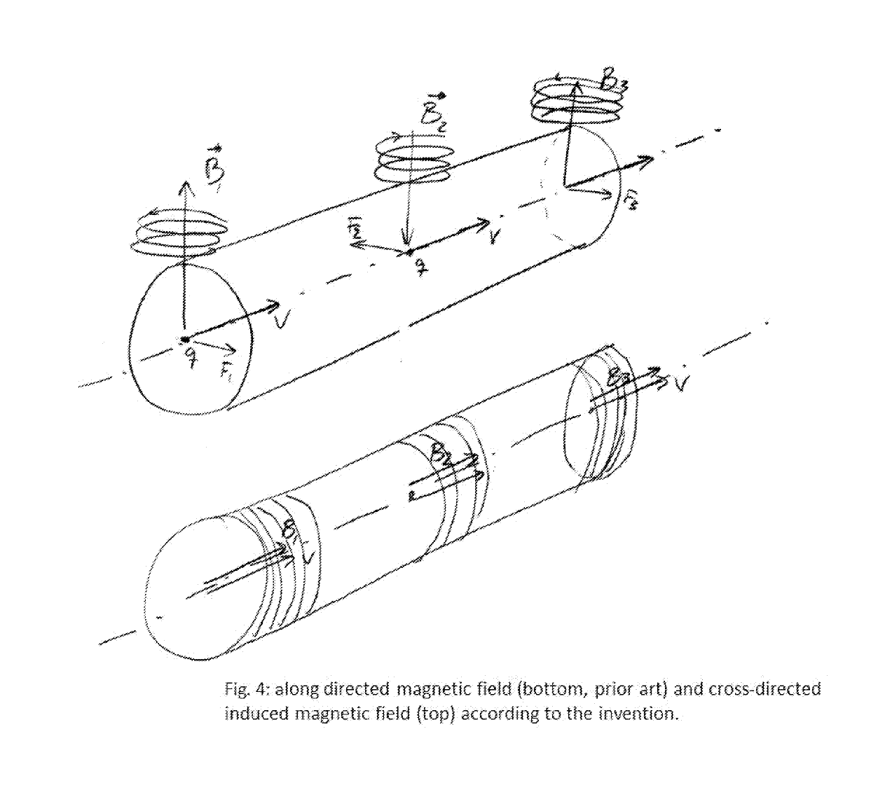

We assume that the fluid or gas containing charged particles, which one may to a certain degree will experience for fluids or gases that moves in synthetic insulating pipes. If we allow the charged particles running along the tube and has a magnetic field that runs across the tube, each particle will experience a force that is perpendicular to the pipe axis and perpendicular to the magnetic field, the vector formula F=q v×B. The greater the angle between v and B is, the greater the F. This suggests that the magnetic field should be across the general flow in the pipe, please see FIG. 4 and the preferred embodiment with two or more electromagnetic coils in FIG. 2. It shall be, according to the invention, two or more distinct magnetic field, and it shall also be in a preferred embodiment to be at least a given distance between the sources of the fields, ie electro-magnets (2).
One may not desire to postpone the fluid/gas for a single magnetic field, but to do this with the magnetic field lines that affect the fluid/gas with a field vector that is transverse on the fluid/gas movement direction, while repeating the treatment with an equally strong and opposite directe fields, at least two in sequence, preferably three or more.
Experiments show that the transverse fields provide the best and fastest results as to achieve an improvement of the air/fuel mixture combustion capability when it reaches the combustion chamber. Longitudinal field shall affect more than just fluid/gas by forming a magnetic field in the longitudinal metal components that are arranged upstream and downstream from the position of magnetic field. Axial fields are quickly affected by the high permeability metals. Magnetic field “DC-field” will lie along or within the high permeability metals such as steel, leaving a very weak field in the center of the pipe where the gas or the fluid is located, if the electromagnet placed parallel to the axis of the pipe. An alternating field will generate undesired ring current in the pipe wall, providing energy lose, if it is made of or comprises electrically conductive material such as steel or steel armer or copper pipe or aluminum pipe, or iron-containing particle contamination in an otherwise insulating plastic pipes.
A transverse magnetic field will break through a metallic pipe wall and influence or magnetize a much smaller area of metal pipe wall than a long directed magnetic field.

Magnetic field (22) induced in each location of the at least one electromagnet (2) comprising a electrical coil (21) receiving energy from a voltage source (3). An electric pulse generator (4) is supplied with voltage from the power source (3) and is arranged to generate electrical pulses (P) with the desired frequency (f) to the electric coil (21).

The device according to the invention has in an embodiment a polarity control device (5) for the electrical pulses (P) wherein the polarity control device is arranged between pulse generator (4) and the electric coil (21), as illustrated in FIG. 2.

The device according to the invention may be arranged so that polarity control device (5) for the electrical pulses (P) is arranged to provide a time delay or phase displacement of the electrical pulses (P) so that in this way may control the polarity of the pulses if the pulses are parts of a pulse with varying polarity as a function of time.

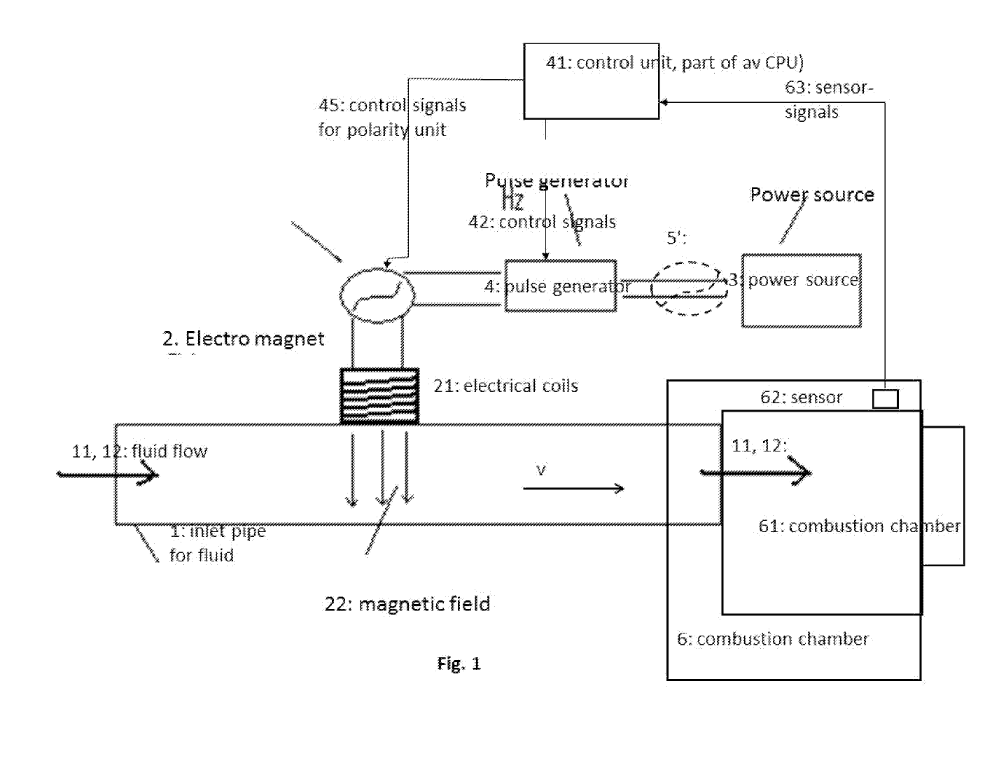

The device according to another embodiment of the invention may be arranged so that a polarity control device (5′) for the electrical pulses (P) is arranged between the pulse generator (4) and the power source (3), as indicated by the dotted lines (5′) in FIG. 1.

The device according to one embodiment of the invention has a control unit (41) that regulates the electrical pulses (P) to be generated in the pulse generator (4). The control unit (41) is arranged to send control signals (42) on the basis of sensor signals (63) from at least one sensor (62) in the combustion engine (6). These control signals (42) determine the electrical pulses (P) form, voltage, amperage, frequency, or pulse pattern, and also their polarity. These sensor signals (63) as a control unit (41) will act on the basis of the for example be one or more of the following parameters:
The engine rotation speed,
Air temperature,
Air flow running through the supply pipe (1) per unit of time;
Air velocity at inlet air supply pipe;
Fuel flow running through the fuel supply pipe (1′) per unit of time;
Fuel temperature before the inlet to the combustion chamber;
Fuel rate in the fuel supply pipe;

The device according to one embodiment of the invention may be arranged so that the forcing signals (45) from the control unit (41) also control the polarity control device (5).

One may imagine that other devices where it will form a continuous flame, such as pan heaters (which has no RPM) or turbines, other parameters may be used as input parameters to the control system to control the pulses of electro magnets.

Because the velocities in the fuel line and inlet air pipe will be different, in an embodiment of the invention generates different pulse speeds in electric magnets that affect the two lines/pipes separately.

The number of electromagnets (2) in an embodiment of the invention is two or more as shown in FIG. 2. The coil of electro magnet (21) may be arranged outside of the supply pipe (1, 1′), inside the pipe (1, 1′) or inside the pipe wall of the pipe (1, 1′).

As mentioned above, at least one of magnetic fields (22) may run generally across at least one of the fluid flows of air or fuel (11, 12) inside the air pipe or the fuel pipe (1, 1′).

The device according to the invention may have two or more electro-magnets (2) arranged with a mutual distance along the flow direction of the fluid flow (11, 12). The distance between two electromagnets may be as large as diameter of each electro-magnets or length. It is possible to mount the electro magnets so that they generate their magnetic field across the flow in the pipe, but that a subsequent magnet forms a magnetic field is rotated slightly, for example between 5 and 30 degrees relative to the magnetic field of present magnet. The frequency (f) of the electrical pulses (P) may be adapted relative to the speed of fluid flow (11, 12) so that a fluid volume (u) exposed to a electromagnets (2) pulse (P) by a first time t1 will move with a velocity (v) to a next electromagnet (2) and is affected by a pulse (P) from the next electromagnet. This may be repeated for one or more additional electromagnets. According to one embodiment of the invention may the above repeated pulses (P) as a fluid volume (u) be exposed to its path, have different directions relative to each other, for example, every second polarity opposite. In this way, may short pulses be stronger than a continuous induced magnetic field, which will save a lot of power and thus a lot of energy and thereby could reduce fuel consumption for this purpose.

It is the inventor's experience that the magnetic influence of the fluid (11, 12) should be made elsewhere in relative to the parts of the supply pipe (1, 1′) than where the turbulence is formed, eddies or unwanted pressure pulsations in the pipe. The electromagnet (2) according to the invention is therefore, according to an embodiment of the invention arranged elsewhere, preferably downstream relative to any such eddies (Eddie), turbulence-forming regions or pressure pulse formation in fluid flow (11, 12) in the tube (1, 1′).

The device according to the invention may be for pre-treatment of fluids into a combustion chamber (61) that may be open in one end, e.g. as part of a flare.

The device according to the invention may be for pre-treatment of fluids to the combustion chamber (61) in a steam generator (63).

The device according to the invention may be for pre-treatment of fluids to the combustion chamber (61) in an internal combustion engine (6) such as a gas turbine.

The device according to the invention may be for pre-treatment of fluids into one or more combustion chamber (61) in an internal combustion engine (6), which may be a piston engine.

The device according to the invention may be for the preparation of a first fluid (11) as fuel, such as heavy oil, light oil, gasoline, diesel, methane, or alcohol. Plant oils such as rapeseed oil may also be used. The second fluid (12) may be air, pure oxygen, nitrogen free air or other oxygen-containing gas.

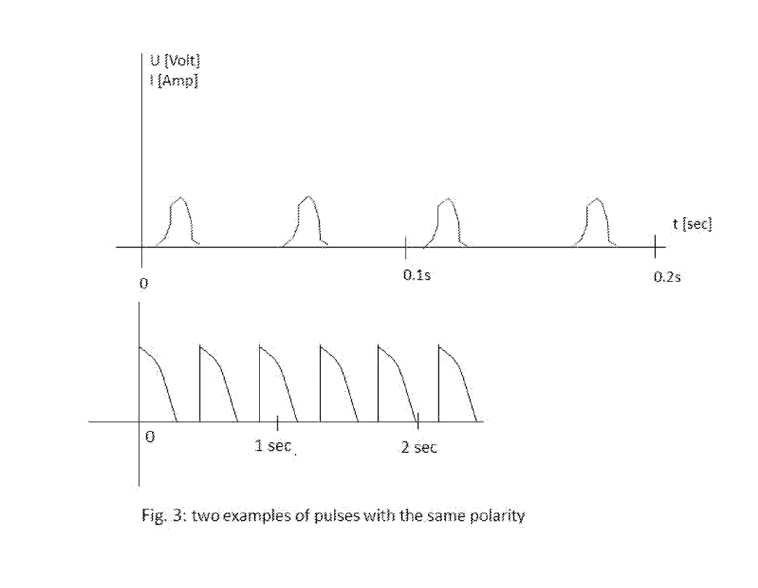

Significant advantage of the invention that follows is that the device according to the invention allows, in contrast to the use of permanent magnets control the strength of the magnetic-pulses generated by fluids (11, 12). It is possible to vary the magnetic field strength and the strengths of the magnetic field that provides a near optimal increase in the efficiency of combustion. Furthermore, it is possible to control the shape of the pulses (P), and frequency of pulses (P) as shown in FIG. 3. In order to form shapes and frequencies of the pulses (P) depending on the flow velocity, flow volume, speed, etc., for the process to be supplied with fuel.

Another advantage is that when you generate electrical pulses one may achieve strong magnetic field in the limited time frame, as shown in FIG. 3, without consuming much electrical energy in terms of having an electro-magnet that consumes a lot of electrical energy by having a constant current and provide a constant strong magnetic field. An example of corresponding electrical pulses are coil that supplies the spark plugs with high voltage pulses, but that consumes very little electricity. It is not known to use such coil systems for generating magnetic pulses through the fuel or combustion air lines, and if an existing coil system e.g for supply of voltage to spark plugs in a gasoline engine used to deliver electrical pulses to a system according to the invention, one has already a frequency control, which varies with RPM of the engine.

1. An apparatus for magnetic pre-treating a first or second flow of fluid in one or more supply pipes for air or fuel to a combustion chamber,
wherein two or more magnetic fields extend through said flow of fluid passing through at least one of said supply pipes,
wherein said magnetic fields are induced by two or more electromagnets each said electromagnet comprising an electrical coil provided with energy from a voltage source;
characterized by
an electrical pulse generator provided with voltage from said voltage source and arranged to generate electrical pulses with a desired frequency to said electrical coil, and
wherein one or more of said magnetic field extend generally athwart of said flow of fluid within said pipe.

2. The apparatus of claim 1, wherein a polarity control device for said electrical pulses is arranged between said pulse generator and said electrical coil.

3. The apparatus according to claim 2, wherein said polarity control device for said electrical pulses is arranged to provide a time delay or phase change of said electrical pulses.

4. The apparatus according to claim 1, wherein a second polarity control device for the electrical pulses is arranged between said pulse generator and said voltage source.

5. The apparatus according to claim 1, wherein said electrical pulses from said pulse generator are controlled by a control unit sending control signals based on sensor signals from one or more sensors in said combustion engine.

6. The apparatus according to claim 5, wherein said control signals determine said electrical pulses' shape, voltage, current, frequency, or pulse pattern.

7. The apparatus according to claim 6, wherein said control signals determine said electrical pulses polarity and thus the direction of said magnetic field induced.

8. The apparatus according to claim 2, wherein control signals from said control unit control said polarity control unit.

9. The apparatus according to claim 1, wherein the number of said electromagnets is two or more.

10. The apparatus according to claim 9, wherein said electromagnet's coil is arranged outside on said pipe.

11. The apparatus according to claim 9, wherein said electromagnet's coil is arranged within said pipe.

12. The apparatus according to claim 9, wherein said electromagnet's coil is arranged within the pipe wall of said pipe.

13. The apparatus according to claim 9, wherein said two or more electromagnets are arranged with mutual separations along the direction of said flow of fluid.

14. The apparatus according to claim 13, wherein said frequency of said electrical pulses is adjusted according to the velocity of said flow of fluid so as for a fluid volume being subject to an electromagnet's pulse at a first instant said fluid volume will move under its velocity to a subsequent electromagnet and become affected by said subsequent electromagnet's subsequent pulse.

15. The apparatus according to claim 1, wherein said electromagnet is arranged downstream relative to possible eddies formed in said flow of fluid in said pipe.

16. The apparatus according to claim 1, wherein said combustion chamber is in a combustion engine which is a piston engine.
